(19) United States
(12) Patent Application Publication
(10) Pub. No.: US 2026/0021475 A1
(43) Pub. Date: Jan. 22, 2026

(54) SYNTHETIC METHODS FOR THE MODIFICATION OF CLAY-BASED SUPPORTS AND THEIR APPLICATIONS IN HETEROGENEOUS CATALYSIS

(71) Applicant: HAMAD BIN KHALIFA UNIVERSITY, Doha (QA)

(72) Inventors: Ahmed ABOTALEB, Doha (QA); Dema ALMASRI, Doha (QA); Alessandro SINOPOLI, Doha (QA)

(21) Appl. No.: 19/099,689

(22) PCT Filed: Aug. 4, 2023
(86) PCT No.: PCT/QA2023/050014

§ 371 Date: Jan. 29, 2025

Related U.S. Application Data
(60) Provisional application No. 63/395,469, filed on Aug. 5, 2022.

(51) Int. Cl. B01J 21/16; B01J 23/755; B01J 35/45; B01J 35/55; B01J 35/61; B01J 35/64; B01J 37/02; B01J 37/04; B01J 37/08

(52) U.S. Cl. CPC B01J 21/16; B01J 23/755; B01J 35/45; B01J 35/55; B01J 35/613; B01J 35/615; B01J 35/647; B01J 37/0205; B01J 37/04; B01J 37/08

(57) ABSTRACT

A method of manufacturing a clay-supported catalyst is provided. The method includes adding halloysite nanotubular (HNT) in water to form an HNT-water mixture, adding Ni precursor salt in water to form a Ni salt solution, adding the Ni salt solution to the HNT-water mixture to form a Ni-HNT mixture, and heating the Ni-HNT mixture at a predetermined temperature for a predetermined time to form a Ni-HINT catalyst. The HNT serves as a catalyst support.

### CROSS-REFERENCE TO RELATED APPLICATION

The present application claims priority to U.S. Provisional Application No. 63/395,469 filed Aug. 5, 2022, and entitled “SYNTHETIC METHODS FOR THE MODIFICATION OF CLAY-BASED SUPPORTS AND THEIR APPLICATIONS IN HETEROGENEOUS CATALYSIS,” the disclosure of which is incorporated by reference herein in its entirety.

### BACKGROUND

Methane (CH₄) and carbon dioxide (CO₂) are the two main atmospheric greenhouse gases responsible for anthropogenic climate change. Dry reforming of methane (DRM) is the process of converting CH₄ and CO₂ into syngas, an important mixture of CO and H₂ used as a building block for world-scale industrial and energy conversion processes, such as Fischer-Tropsch (FT), and for the synthesis of fuels and high value added chemicals.

Noble metal catalysts, such as Rh, Ru, Pt, and Pd, have shown to be the most active for methane reforming; however, these metal catalysts may be costly. Among metal catalysts, Ni may have gained more attention throughout the years due to its low cost, availability, and good performance. However, Ni may not be as effective as the above-discussed noble catalysts as it may suffer from significant deactivation due to coke formation and sintering at high temperatures.

### SUMMARY

The present disclosure generally relates to a halloysite nanotubular (HNT) clay based Ni catalyst for dry reforming of methane and method for manufacturing the same.

In light of the present disclosure, and without limiting the scope of the disclosure in any way, in an aspect of the present disclosure, which may be combined with any other aspect listed herein unless specified otherwise, a method of manufacturing a clay-supported catalyst is provided. The method includes adding halloysite nanotubular (HNT) in water to form an HNT-water mixture, adding Ni precursor salt in water to form a Ni salt solution, adding the Ni salt solution to the HNT-water mixture to form a Ni-HNT mixture, and heating the Ni-HNT mixture at a predetermined temperature for a predetermined time to form a Ni-HNT catalyst. The HNT serves as a catalyst support.

Additional features and advantages of the disclosed systems and methods are described in, and will be apparent from, the following Detailed Description and the Figures.

### BRIEF DESCRIPTION OF THE FIGURES

FIG. 1 is a flowchart illustrating an example method for manufacturing a clay-supported catalyst according to an example of the present disclosure.

FIG. 2 is a diagram showing an example method of manufacturing a clay-supported catalyst according to an example of the present disclosure.

FIG. 3 shows an experimental setup for the Ni/HNT synthesis using a wet impregnation procedure.

FIG. 4 is a graph showing the specific surface area and pore size of example clay-supported catalysts with 13 wt % Ni loading on raw HNT supports with different precursors.

FIG. 5 is a graph showing XRD patterns of an example clay-supported catalyst with 13 wt % Ni loading on raw HNT supports with different precursors.

FIG. 6 is a TEM and EDS elemental mapping of the elements throughout an example clay-supported catalyst.

FIG. 7A and 7B are TEM images of raw HNT and nitric acid treated HNT, respectively.

FIG. 8 is a graph showing the specific surface area and pore size of example clay-supported catalysts with nickel loaded on HNO₃ acid treated HNT using several nickel precursors.

FIG. 9 depicts an EDX-TEM elemental mapping and distribution of elements within the catalyst on nickel loaded HNO₃ acid treated HNT.

FIG. 10 is a graph showing the specific surface area and pore size of example clay-supported catalysts with 10 and 13 wt % Ni loading on the H₂SO₄ treated HNT with different nickel precursors.

FIG. 11 shows an EDX elemental mapping and distribution of the elements within the catalyst with nickel loading on the H₂SO₄ treated HNT.

FIG. 12 is a graph showing the specific surface area and pore size of example clay-supported catalysts with 10 wt % Ni loading on H₂SO₄ treated HNT supports with different promoters.

FIG. 13 is TEM images of Ni-AHNT with promoters Ce, La, Mg, and Y.

FIG. 14 is TEM images of nickel loaded on commercial catalysts.

FIG. 15 is a graph showing specific surface areas of raw HNT, acid treated HNT, Ni loaded HNT, and Ni loaded on commercial catalysts.

FIG. 16 is a graph showing pore sizes of raw HNT, acid treated HNT, Ni loaded HNT, and Ni loaded on commercial catalysts.

FIG. 17 is a graph showing the Si/Al ratio of example catalysts with different amounts of nickel.

FIG. 18 is a graph showing the Ni wt % on example catalysts with different amounts of nickel, measured using XPS analysis.

FIG. 19 shows a MicroEffi Reactor used for catalyst performance test.

FIG. 20 shows an example reactor PLC display that is programed for DRM reaction.

FIG. 21 is a graph showing a reaction temperature and a pressure drop.

FIG. 22 is a graph showing reactor outlets measured by a mass spectrometer.

### DETAILED DESCRIPTION OF EXAMPLE EMBODIMENTS

The present disclosure generally relates to an HNT clay-based Ni catalyst for dry reforming of methane and method for manufacturing the same.

There has been a need for innovative technologies for optimal exploitation of gas reserves, especially with constant changing market scenarios. Aspects of the present disclosure may provide a method for optimal exploitation of hydrocarbon resources and long-term maintenance of strategic reserves by developing effective catalysts for converting raw natural gas to value added products, as well as de-bottlenecking the existing issues associated with the achievement of efficient gas conversion processes.

Methane (CH₄) and carbon dioxide (CO₂) are the two main atmospheric greenhouse gases responsible for anthropogenic climate change. Dry reforming of methane (DRM) is the process of converting CH₄ and CO₂ into syngas, an important mixture of CO and H₂ used as a building block for world-scale industrial and energy conversion processes, such as Fischer-Tropsch (FT), and for the synthesis of fuels and high value added chemicals.

Over the last decade, DRM has often been researched to be integrated with steam methane reforming (SMR) for producing syngas with different CO/H₂ ratios, offering potential use in a larger variety of downstream processes. However, applications of DRM still suffer of high coke formation and, accordingly, catalyst deactivation.

Aspects of the present disclosure may provide clay-supported catalysts for heterogeneous catalytic gas conversion processes for the dry reforming of methane. The noble metal catalysts, which include Rh, Ru, Pt, and Pd have shown to be the most active for methane reforming; however, they may be costly. Among metal catalysts, Ni has gained more attention throughout the years due to its low cost, availability, and good performance. However, Ni may not be as effective as the above noble catalysts as it may suffer from significant deactivation due to coke formation and sintering at high temperatures. Halloysite nanotubes (HNT) may be suitable support for Ni-based catalysts due to their superior resistance to coking and Ni-sintering in addition to being abundant and cost-effectiveness.

According to an example embodiment of the present disclosure, an HNT clay may be used as a support to load Ni catalyst, and the synthesized nickel clay catalysts may be used for DRM. The catalyst supports may be raw halloysite clay (HNT)(Al₂Si₂O₅(OH)₄), nitric acid (HNO3) treated HNT (AHNT1) and sulfuric acid (H2SO4) treated HNT (AHNT2), as well as cerium oxide (CeO₂), magnesium oxide (MgO), and silica (SiO₂). The nickel based catalysts may be also synthesized with promoters (e.g., cerium (Ce), lanthanum (La), magnesium (Mg), and yttrium (Y)).

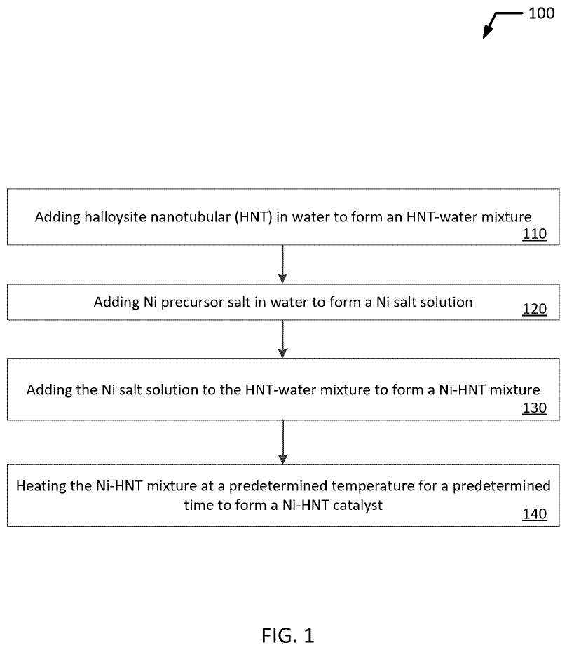

FIG. 1 is a flowchart illustrating an example method 100 for manufacturing a clay-supported catalyst according to an example of the present disclosure. Although the example method 100 is described with reference to the flowchart illustrated in FIG. 1, it will be appreciated that many other methods of performing the acts associated with the method may be used. For example, the order of some of the blocks may be changed, certain blocks may be combined with other blocks, and some of the blocks described are optional.

The method 100 may include adding HNT in water to form an HNT-water mixture (e.g., suspension) (block 110). For example, the HNT may be stirred in de-ionized water at a predetermined speed. The predetermined speed may be in a range of about 300 rpm to about 800 rpm. In some examples, a weight ratio of the HNT to the water may be in a range of about 1:5 to about 1:100.

In some examples, Ni precursor salt may be added in water to form a Ni salt solution (block 120). In some examples, a weight ratio of the Ni precursor salt to the water may be in a range of about 1:10 to about 1:100.

The Ni salt solution may be added to the HNT-water mixture to form a Ni-HNT mixture (block 130). In some examples, the Ni-HNT mixture may be stirred for a predetermined time at a predetermined speed. The predetermined time may be in a range of about 30 minutes to about 60 minutes. The predetermined speed may be in a range of about 300 rpm to about 800 rpm. In some examples, a weight ratio of the Ni precursor salt to the HNT may be in a range of about 1:100 to about 1:5.

In some examples, the Ni-HNT mixture may be refluxed at a predetermined temperature for a predetermined time at a predetermined speed. The predetermined temperature may be in a range of about 80° C. to about 100° C. The predetermined time may be in a range of about 9 hours to about 12 hours. The predetermined speed may be in a range of about 300 rpm to about 800 rpm.

In some examples, the Ni-HNT mixture may be further washed and centrifuged predetermined number of times (e.g., 2-5 times), for example, to remove any excess nickel, then dried at a predetermined temperature for a predetermined time. The predetermined temperature may be in a range of about 90° C. to about 120° C. The predetermined time may be in a range of about 8 hours to about 14 hours.

Then, the Ni-HNT mixture may be heated at a predetermined temperature for a predetermined time to form a Ni-HNT catalyst (block 140). In some examples, the predetermined temperature may be in a range of about 700° C. to about 900° C., for example, about 700° C. to about 770° C., about 770° C. to about 830° C., or about 830° C. to about 900° C. In other examples, the Ni-HNT mixture may be heated at any other suitable temperature.

In some examples, the predetermined time may be in a range of about 4 hours to about 8 hours, for example, about 4 hours to about 5 hours, about 5 hours to about 6 hours, about 6 hours to about 7 hours, or about 7 hours to about 8 hours. In other examples, the Ni-HNT mixture may be heated for any other suitable period of time.

In some examples, urea may be added to the Ni-HNT mixture, for example, before the heat treatment. In some examples, the Ni-HNT mixture with urea may be stirred for a predetermined time at a predetermined speed. The predetermined time may be in a range of about 30 minutes to about 90 minutes. The predetermined speed may be in a range of about 300 rpm to about 800 rpm. In some examples, a weight ratio of the urea to the Ni-salt may be in a range of about 1:1 to about 1:0.3.

In some examples, the HNT may be treated with a strong acid instead of adding the HNT in the water to form the HNT-water mixture. In some examples, the strong acid may be or include at least one of nitric acid (HNO₃), sulfuric acid (H₂SO₄), and hydrochloric acid (HCl). In other examples, the strong acid may be or include any other suitable strong acid. In some examples, a weight ratio of the strong acid to the HNT may be about 5:1 to about 100:1, for acids with a concentration ranging from 1N to 4N.

A Ni-HNT catalyst may be formed based on one or more methods discussed above. In the Ni-HNT catalyst, the Ni may serve as a catalyst, and the HNT may serve as a catalyst support. In some examples, the Ni-HNT catalyst may be a mono-metallic catalyst. That is, the Ni may be the only metallic component in the Ni-HNT catalyst (other than any metallic component in incidental impurities). As used herein, incidental impurities may mean an impurity or element that is not intentionally added to the Ni-HNT catalyst composition, is present as an impurity, and/or is in trace amounts. In other examples, the Ni-HNT catalyst may include another metallic component other than Ni.

In some examples, a specific surface area of the Ni-HNT catalyst may be in a range of about 30 m²/g to about 300 m²/g. In other examples, the Ni-HNT catalyst may have any other suitable specific surface area.

In some examples, the pore size of the Ni-HNT catalyst may be in a range of about 5 nm to about 30 nm. In other examples, the Ni-HNT catalyst may have any other suitable pore size.

In some examples, the method may further include adding a promotor to the Ni-HNT mixture. Examples of the promotor may include at least one of Ce, Mg, Y, La, In, Sm, Mn, Gd, Mg, Na, K, Zr, Fe, Sn, and Ba. In some examples, the addition of the Ni salt solution and the promotor may be performed sequentially according to a sequential impregnation method. For example, the sequential impregnation may be conducted by adding the Ni salt solution to the HNT-water mixture/acid-treated HNT to form a Ni-HNT mixture, and then a promotor may be added to the Ni-HNT mixture to form a Ni-HNT-promotor mixture. In some examples, the urea may be added to the Ni-HNT-promotor mixture, for example, after the promotor is added to the Ni-HNT mixture.

Aspects of the present disclosure may provide a clay-supported catalyst. The clay-supported catalyst may include a catalyst including Ni and a catalyst support. In some examples, the catalyst support may be or include HNT. In some examples, a weight ratio of the Ni to the HNT may be in a range of about 1:100 to about 1:5. In some examples, instead of Ni, any other suitable element may be used, such as cationic elements of groups from 1 to 16 of the IUPAC periodic table of the elements, including cations of lanthanides and actinides (Co, Cu, Pt, Pd, Ru, Rh, Ce, Mg, Y, La, In, Sm, Mn, Gd, Mg, Na, K, Zr, Fe, Sn, or Ba).

In some examples, a specific surface area of the clay-supported catalyst may be in a range of about 170 m²/g to about 190 m²/g. In other examples, the clay-supported catalyst may have any other suitable specific surface area.

A pore size of the clay-supported catalyst may be in a range of about 7 nm to about 12 nm. In other examples, the clay-supported catalyst may have any other suitable pore size.

In some examples, the HNT may be treated with a strong acid. For example, the HNT may be treated with sulfuric acid (H₂SO₄). In other examples, the HNT may be treated with any other suitable strong acid, such as nitric acid (HNO₃), hydrochloric acid (HCl), and/or hydrofluoric acid (HF). In some examples, the HNT may be treated using a strong base.

In some examples, the clay-supported catalyst is a mono-metallic catalyst. In other examples, the clay-supported catalyst may include multiple metallic components (e.g., any two or more components from Ni, Co, Cu, Pt, Pd, Ru, Rh, Ce, Mg, Y, La, In, Sm, Mn, Gd, Mg, Na, K, Zr, Fe, Sn, or Ba).

### EXAMPLES

Some example clay-supported catalysts were prepared as discussed in more details below.

### Example 1

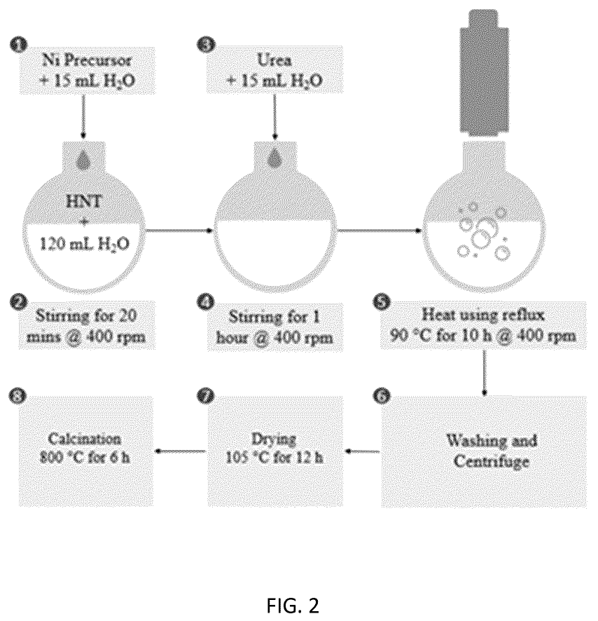

Nickel supported on raw HNT was prepared, for example, through a wet impregnation synthesis method as shown in FIG. 2. Nickel precursor salt was dissolved in water and stirred for 20 min at 400 rpm followed by which urea was added dropwise and stirred for 1 h at 400 rpm. The solution was then refluxed for 90° C. for 10 h at 400 rpm. The final product was washed and centrifuged 3 times to remove any excess nickel, then dried for 105° C. for 12 h followed by undergoing calcination at 800° C. for 6 h. Nickel was added at 10 and 13 wt % in order to determine the effect of nickel amount added on the amount actually loaded on the HNT. Different nickel precursor salts were used to test the effect of precursor salts on nickel dispersion, homogeneity, or agglomeration. The nickel precursor salts used were nickel chloride, nickel acetate, and nickel nitrate.

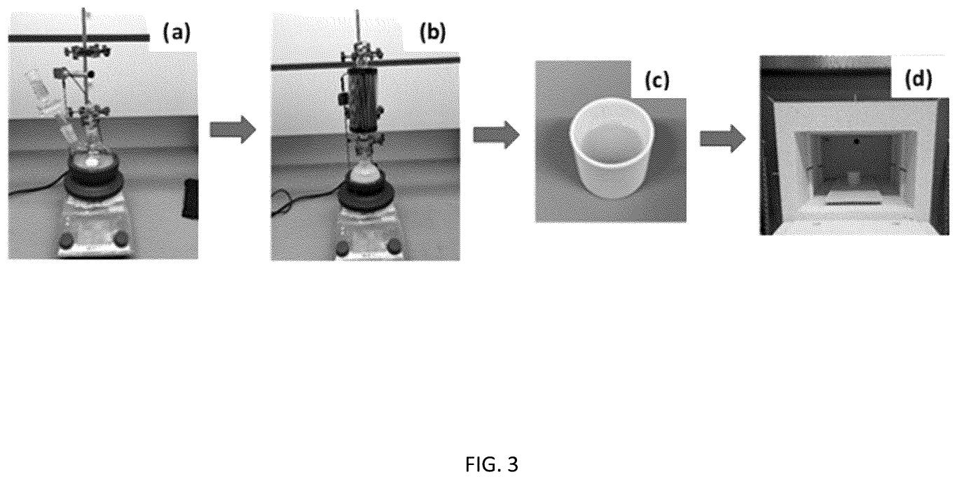

FIG. 3 shows an experimental setup for the Ni/HNT synthesis using the wet impregnation procedure. As shown in FIG. 3, in step (a), HNT is stirred in de-ionized water at 400 rpm followed by the dropwise addition of dissolved Ni salt. In step (b), the HNT is stirred and heated overnight and refluxed for 90° C. for 10 h at 400 rpm. Then, as shown in step (c), a final mixture of Ni-HNT is obtained after the refluxing, which is subject to calcination at 800° C. for 6 h.

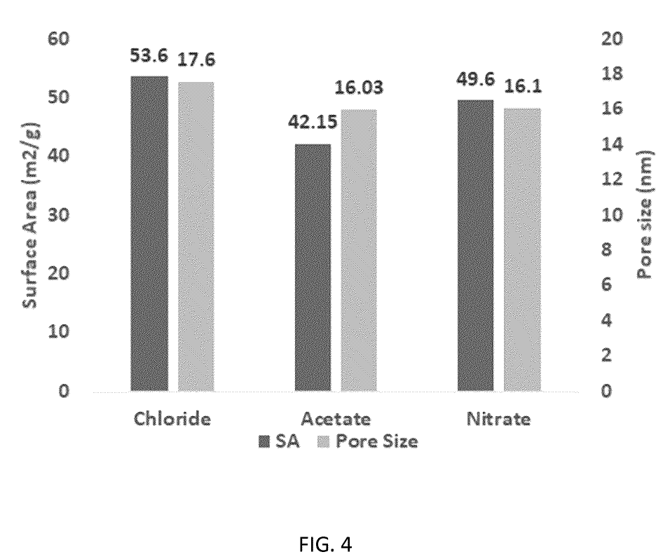

The BET surface area and pore size of the catalyst with 13 wt % Ni loading on raw HNT supports with different precursors is shown in FIG. 4. No significant change in the specific surface area (SA) and pore size was observed with the different precursor salts.

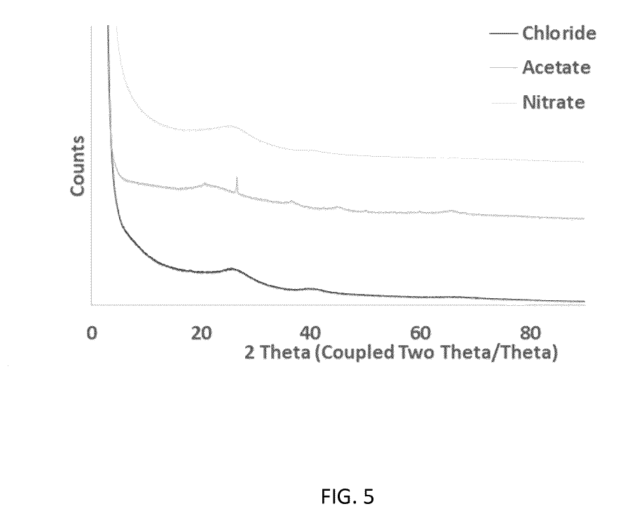

FIG. 5 depicts the XRD patterns for the nickel loaded on raw HNT using the different nickel precursors. Similar XRD patterns were observed, which may indicate no change in the morphology or crystallinity of the catalyst.

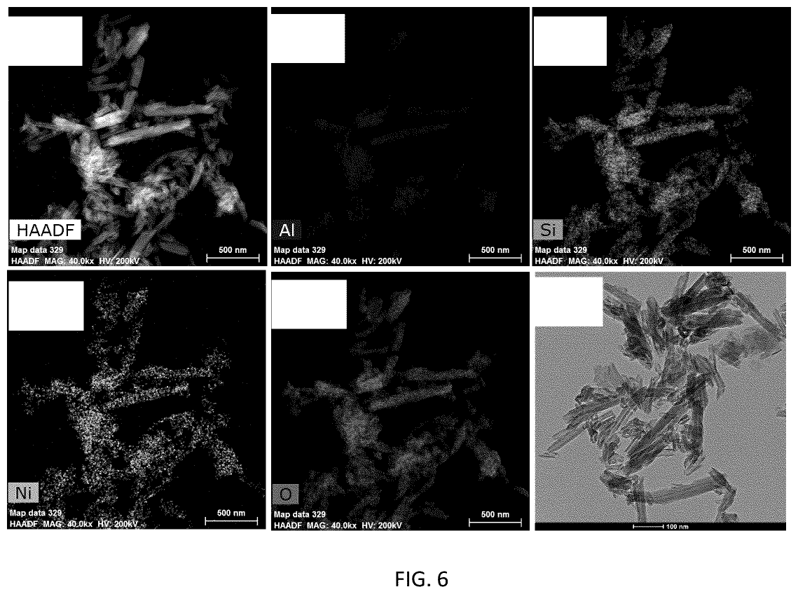

FIG. 6 depicts a TEM and EDS elemental mapping of the elements throughout the synthesized catalyst. FIG. 6d shows a homogenous distribution of nickel throughout the support. FIG. 6f is the TEM image of the nickel loaded HNT, which shows the tubular structure of HNT and well dispersed Ni.

### Example 2

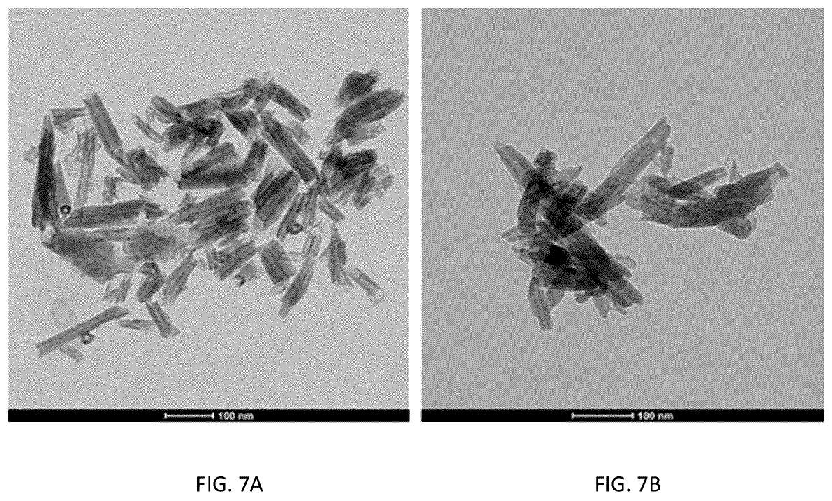

In this example, nickel supported on acid treated HNT was prepared. For example, HNT was treated with nitric acid, sulphuric acid, and hydrogen chloride in order to remove any impurities, increase the surface area, etch the alumina to provide more pores as well as more active sites for nickel and promoter loading. The acid treated halloysite nanotubes (AHNT) was prepared in the laboratory. Initially, raw halloysite nanotubes were refluxed at 80° C. with 3M of HNO₃, H₂SO₄, and HCl with constant stirring at 400 rpm for 8 h to remove any impurities in the clay material as well as to etch the inner lumen in order to provide more space for the catalyst. Afterwards, the acid treated support was calcined at 1000° C. for 6 hr. TEM images of the raw HNT and acid treated HNT are shown in FIGS. 7A and 7B. FIG. 7B shows the pore formation on the HNTs after acid treatment.

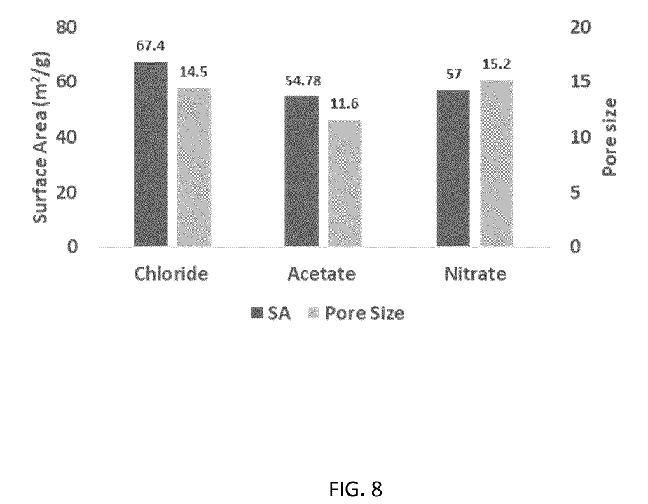

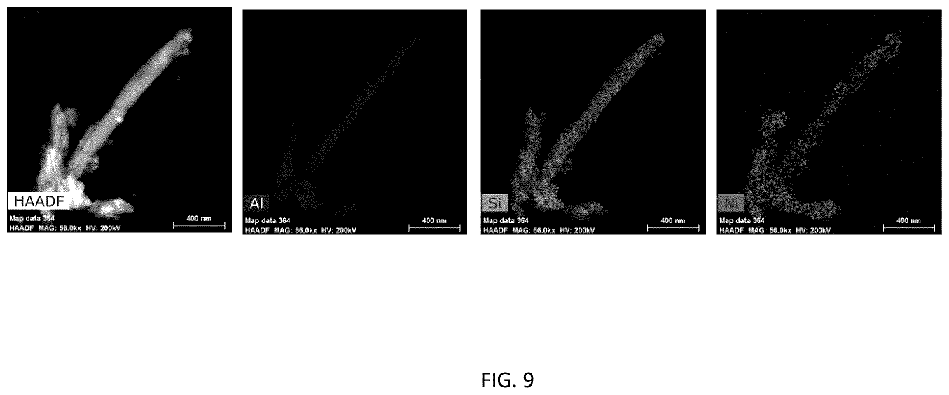

The BET surface area and pore size of the nickel loaded on HNO₃ acid treated HNT using several nickel precursors is shown in FIG. 8. The specific surface area was found to increase slightly after treatment with nitric acid while the pore size was decreased when compared to the specific surface area and pore size of the catalyst with nickel loaded on raw HNT (see FIG. 4). FIG. 9 depicts an EDX-TEM elemental mapping and distribution of elements on the nickel loaded HNO₃ acid treated HNT.

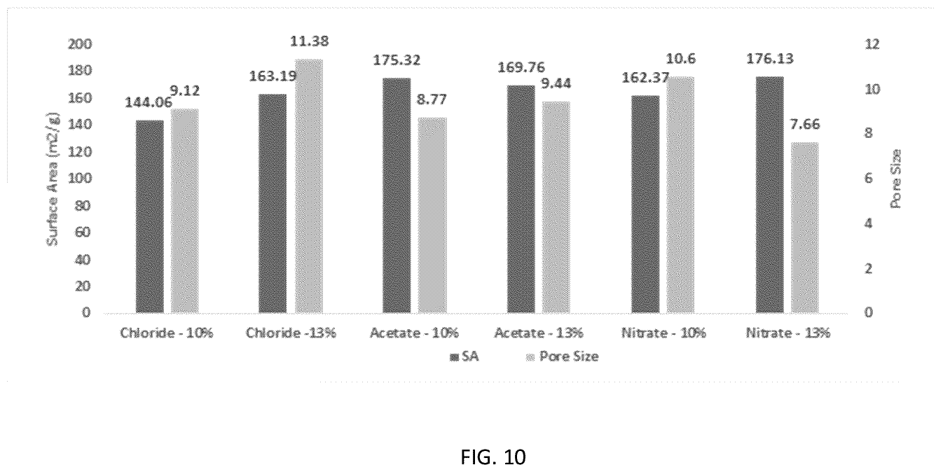

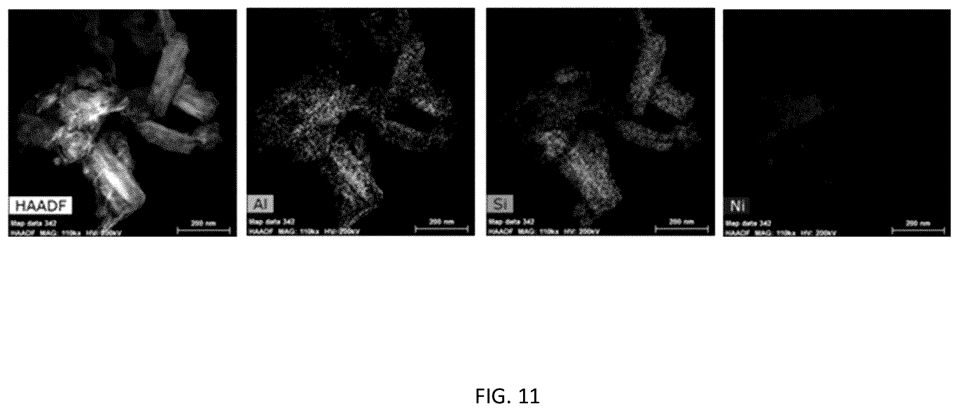

The BET surface area and pore size of example clay-supported catalysts with 10 and 13 wt % Ni loading on the H₂SO₄ treated HNT with different nickel precursors is depicted in FIG. 10. The specific surface area was found to increase by more than 2 folds when compared to the specific surface area of the catalyst with nickel loaded on raw HNT (see FIG. 4). It showed a relatively higher surface area and lower pore size when compared to the nitric acid treated HNT (see FIG. 8). A comparison of 10 wt % and 13 wt % nickel salt loading does not show a significant change in surface area, except for the nickel chloride precursor. FIG. 11 shows the EDX elemental mapping and distribution of the elements within the catalyst with Ni loading on the H₂SO₄ treated HNT.

### Example 3

In this example, nickel supported on acid treated HNT with promoters was prepared. For example, the synthesis of Ni-AHNT with promoters was performed via sequential impregnation. Similar to the wet impregnation procedure done for the Ni-AHNT, this synthesis was conducted by adding the nickel first following through the synthesis steps as shown in FIGS. 2 and 3, then adding the promoter (Ce, La, Mg, or Y) as well and following through the same synthesis procedure as in FIGS. 2 and 3. This method was found to be more successful when compared to the co-impregnation method where promoter particles were agglomerated and non-homogenously dispersed.

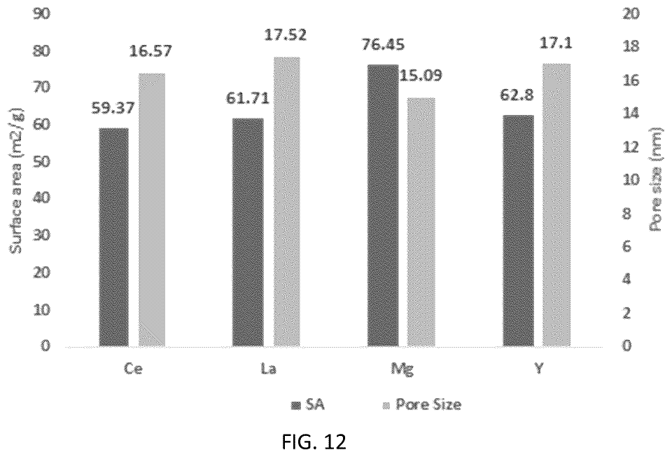

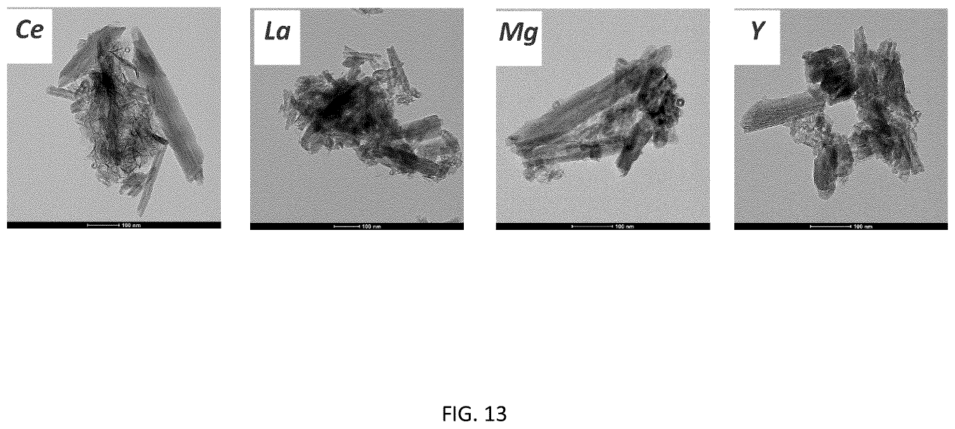

FIG. 12 shows the BET surface area and pore size of catalysts with 10 wt % Ni loading on H₂SO₄ treated HNT supports with different promoters, while FIG. 13 depicts the TEM images of the Ni-AHNT with promoters Ce, La, Mg, and Y. As shown in these figures Ni+Mg on AHNT recorded the heighted surface area and lowest pore size.

### Example 4

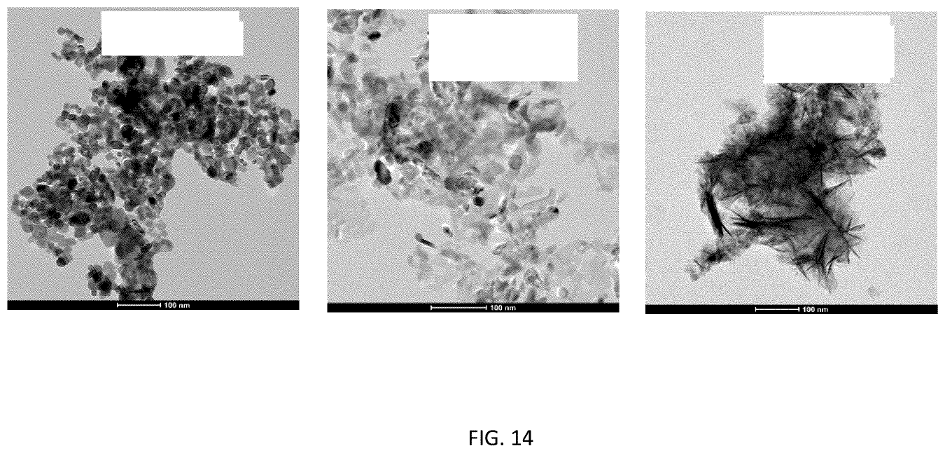

In this example, nickel loaded commercial catalysts was prepared. For example, nickel was loaded on commercial catalysts CeO₂, MgO, and SiO₂ using the same wet impregnation procedure illustrated in FIGS. 2-3 and described above with respect to these figures. TEM images of the nickel loaded on the commercial catalysts are shown in FIG. 14.

### Summary of Examples 1-4

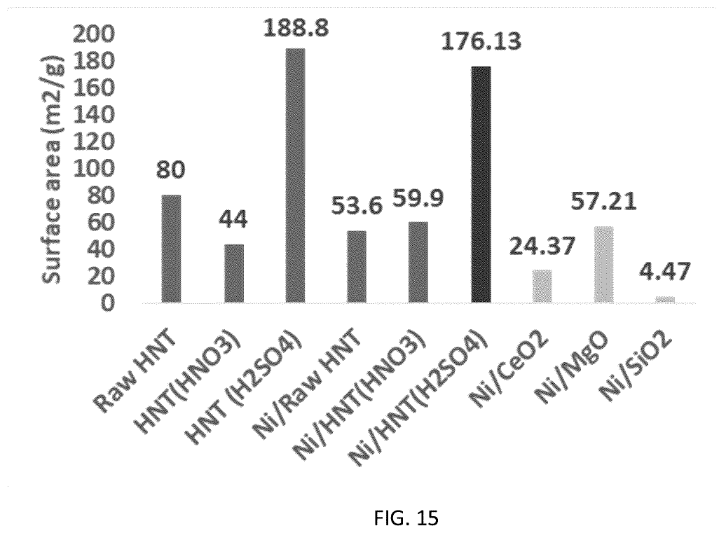

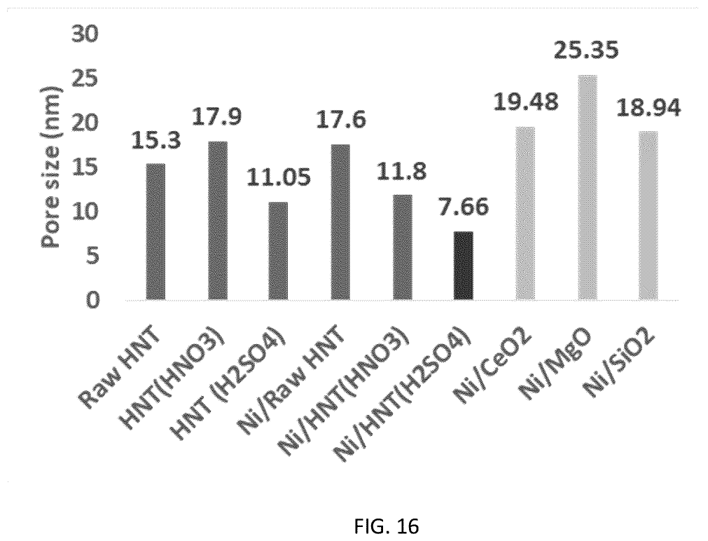

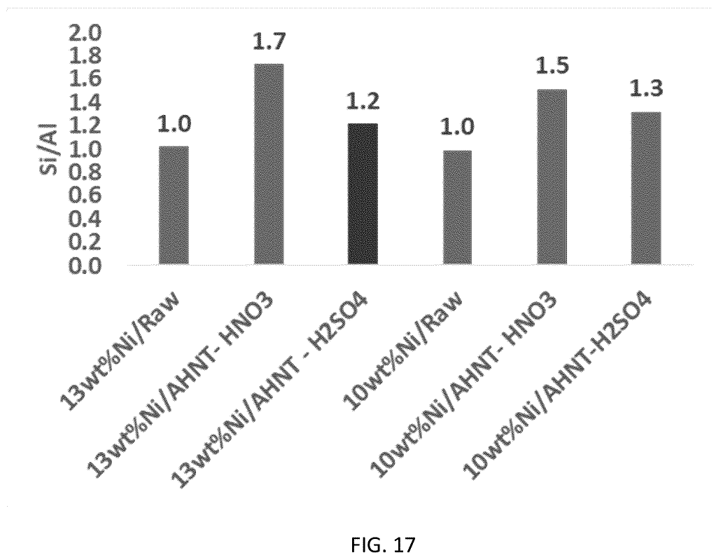

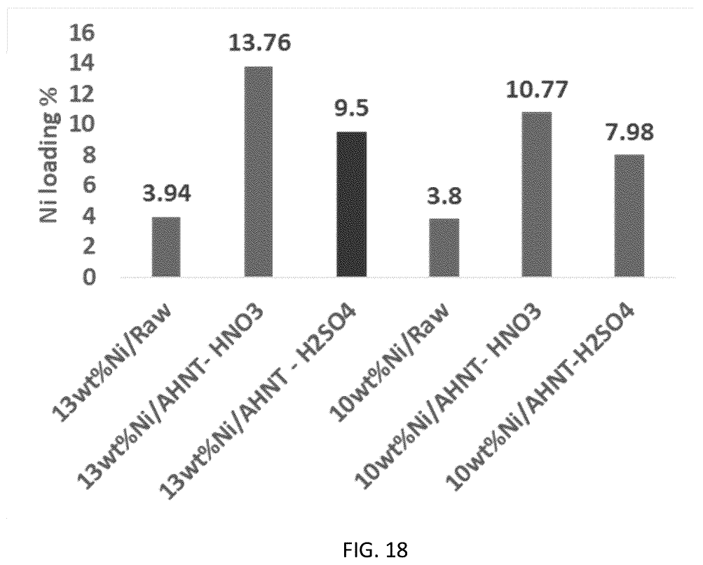

FIGS. 15 to 18 provide a summary of the measured results for the catalysts discussed in the previous sections. FIGS. 15 and 16 summarize the specific surface area and pore size, respectively, of the raw HNT, acid treated HNT, Ni loaded HNT, and Ni loaded on commercial catalysts. This was measured using the BET ASAP 2024 instrument. FIG. 17 depicts the Si/Al ratio of these catalysts with different amounts of nickel. FIG. 18 illustrates the Ni wt % on the catalysts, measured using XPS analysis.

The measured results suggest that Ni was loaded successfully on both raw HNT and acid treated HNT in addition to the commercial catalysts (SiO₂, MgO and CeO₂). Loading other metal/promoters (Ce, LA, Mg, Y) to Ni on HNT was successful. The starting Ni-precursor seems to have no effect on the surface area nor on the pore size, while same Ni-loading was achieved on all cases. The acid treatment of HNT was shown to alter its structure and properties. H₂SO₄ treatment of HNT showed a higher surface area and lower pore size, while the HNO₃ treatment of HNT showed higher Ni-loading on the surface and higher Si/Al ratio.

### Example 5

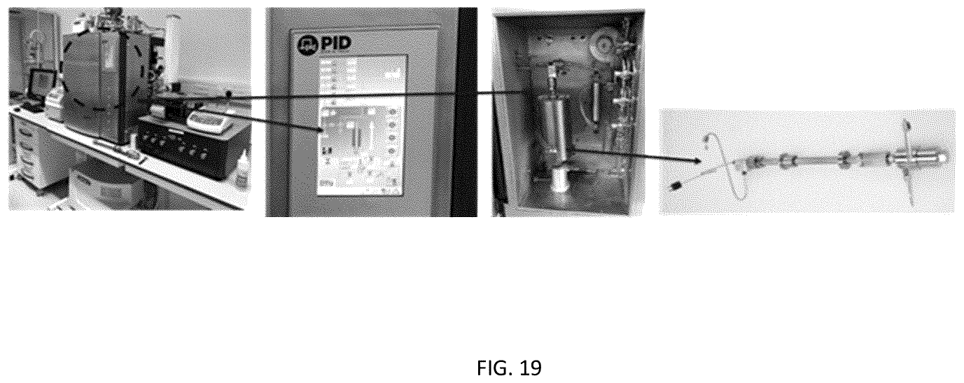

In this example, the performance of some example catalysts were tested. Isothermal fixed bed flow reactor (MicroEffi Reactor, See FIG. 19) was used as laboratory scale reactor for catalytic screening and kinetic studies of different solid catalysts for DRM reactions. It operates under dynamic conditions, whereby the reactants are continuously fed to the reactor and products are continuously collected for analysis. This tool is largely used for developing new catalyst candidates for industrial processes. Within the laboratory for this test, this reactor was equipped with a PLC control, an automated sampling system, and was attached to gas analyzer mass spectrometer. The performance of both conventional and novel catalysts were tested for porous structure, morphology, and surface area.

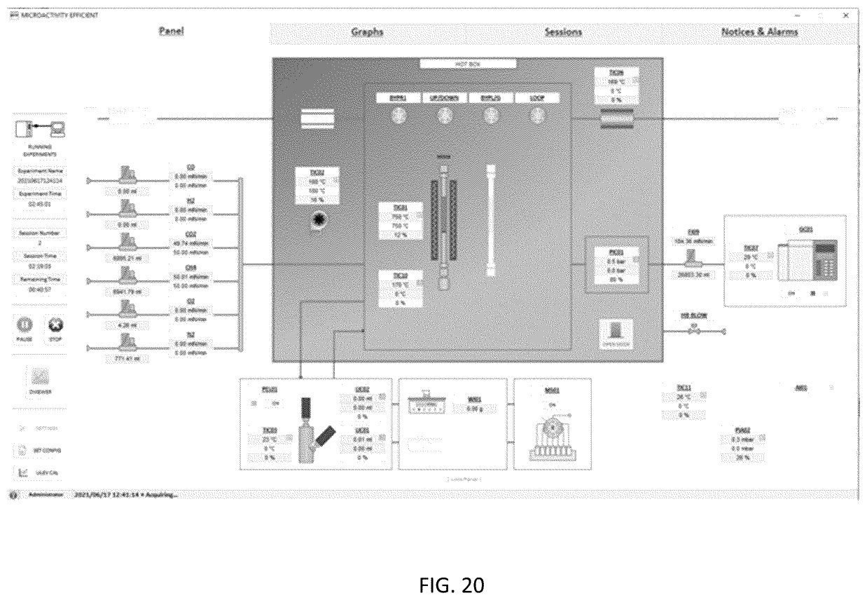

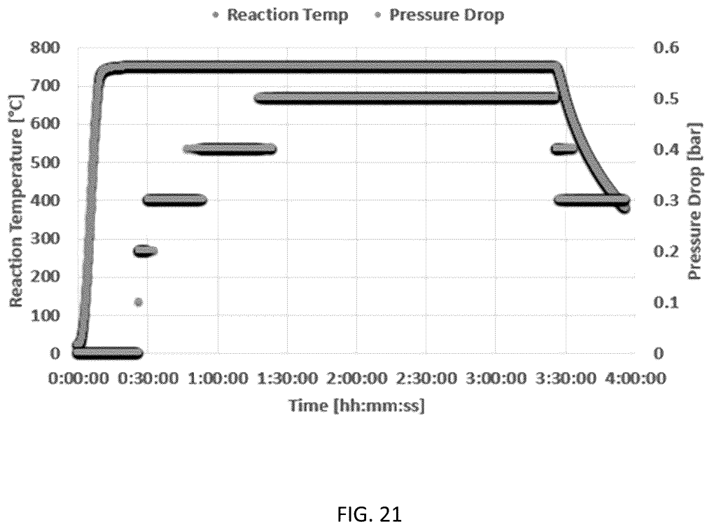

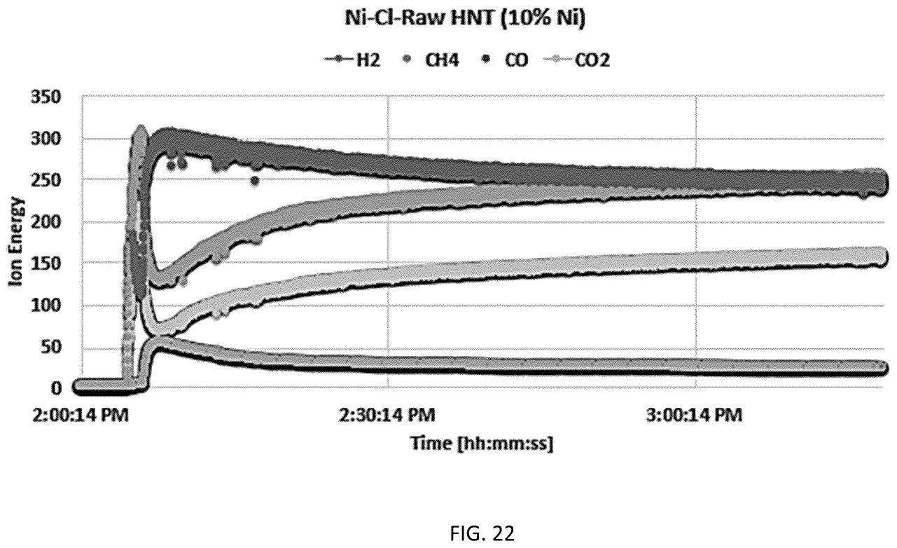

FIG. 20 reflects the reactor PLC display after being programed for DRM reaction, where the reaction temperature is fixed at 750° C. and the CH₄: CO₂ feed ratio is 1:1, while the mass spectrometer is continuously measuring the products (CO and H₂) and any unreacted CH₄ and/or CO₂. Ni catalyst loaded on HNT was tested for performance evaluation, where the catalyst was first purged with N₂ to remove any impurities, followed by H₂ flowing at reaction temperature for several hours for catalyst reduction and moisture removal, whereby, the catalyst is fully reduced. Then, CH₄ and CO₂ are added at a flow of 50 mN/min each until the set reaction time is achieved. Finally, the reaction was stopped and N₂ was purged into the system. FIG. 21 shows the reaction temperature at 750° C., while pressure drop peaked at 0.5 bars. FIG. 22 shows the mass spectrometer outlet compositions, where the following performances were recorded: CH₄ conversion: 85%; CO₂ conversion: 82%; H₂ selectivity: 98%; and CO selectivity: 92%.

As discussed above, aspects of the present disclosure may address the existing problems in the current methane thermal conversion technologies, for example, by providing a clay-based catalyst that may show stable performance at long-term experiments. The clay-supported catalysts according to the present disclosure may be much cheaper than commercial catalysts (e.g., 4,000 times cheaper than commercial catalyst). For example, raw HNT price is around $350/ton, acid treated HNT is estimated at $606/ton, while alumina (trilobes) is reported as $24,255/ton. HNT support may be naturally available, chemically and thermally stable, have a unique tubular structure and a relatively good surface area (22-82 m²/g). Halloysite nanotubes may be a suitable support for Ni-based catalysts due to their superior resistance to coking and Ni-sintering.

The clay-supported catalysts according to the present disclosure may show 85% CH₄ conversion and 98% products selectivity, use CO₂ as the oxidizing agent, help effectively convert two greenhouse gases into a valuable fuel, and overall show lower emissions than SMR.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of manufacturing a clay-supported catalyst, the method comprising:
adding Ni precursor salt in water to form a Ni salt solution;
adding the Ni salt solution to halloysite nanotubular (HNT) to form a Ni-HNT mixture; and
heating the Ni-HNT mixture at a predetermined temperature for a predetermined time to form a Ni-HNT catalyst, wherein the HNT serves as a catalyst support.

2. The method of claim 1, wherein the predetermined temperature is in a range of 700° C. to 900° C.

3. The method of claim 1, wherein the predetermined time is in a range of 4 hours to 8 hours.

4. The method of claim 1, wherein a weight ratio of the Ni precursor salt to the water is in a range of about 1:10 to about 1:100.

5. The method of claim 1, wherein a weight ratio of the Ni precursor salt to the HNT is in a range of about 1:100 to about 1:5.

6. The method of claim 1, further comprising adding urea to the Ni-HNT mixture.

7. The method of claim 6, wherein a weight ratio of the urea to the Ni-salt is in a range of about 1:1 to about 1:0.3.

8. The method of claim 1, further comprising treating the HNT with a strong acid before adding the Ni salt solution to the HNT.

9. The method of claim 8, wherein the strong acid comprises at least one of nitric acid (HNO₃), sulfuric acid (H₂SO₄), and hydrochloric acid (HCl).

10. The method of claim 9, wherein a weight ratio of the strong acid to the HNT is about 5:1 to about 100:1, for acids with a concentration ranging from 1N to 4N.

11. The method of claim 1, wherein a specific surface area of the Ni-HNT catalyst is in a range of about 30 m²/g to about 300 m²/g.

12. The method of claim 1, wherein a pore size of the Ni-HNT catalyst is in a range of about 5 nm to about 30 nm.

13. The method of claim 1, further comprising adding a promotor to the Ni-HNT mixture.

14. The method of claim 13, wherein the promotor comprises at least one of Ce, Mg, Y, La, In, Sm, Mn, Gd, Mg, Na, K, Zr, Fe, Sn, and Ba.

15. The method of claim 13, wherein the addition of the Ni salt solution and the promotor are performed sequentially according to a sequential impregnation method.

16. The method of claim 1, wherein the Ni-HNT catalyst is a mono-metallic catalyst.

17. A clay-supported catalyst comprising:
a catalyst comprising Ni;
a catalyst support comprising halloysite nanotubular (HNT), wherein the HNT is treated with a strong acid,
wherein a weight ratio of the Ni to the HNT is in a range of about 1:100 to about 1:5;
wherein a specific surface area of the clay-supported catalyst is in a range of about 30 m²/g to about 300 m²/g; and
a pore size of the clay-supported catalyst is in a range of about 5 nm to about 30 nm.

18. The clay-supported catalyst of claim 17, wherein the strong acid comprises sulfuric acid (H₂SO₄).

19. The clay-supported catalyst of claim 17, wherein the clay-supported catalyst is a mono-metallic catalyst.

20. The clay-supported catalyst of claim 17, further comprising a promotor, wherein the promotor comprises at least one of Ce, Mg, Y, La, In, Sm, Mn, Gd, Mg, Na, K, Zr, Fe, Sn, and Ba.
